(19) United States
(12) Patent Application Publication
(10) Pub. No.: US 2018/0094778 A1
(43) Pub. Date: Apr. 5, 2018

(54) LIGHT BULB WITH UNIVERSAL SERIAL BUS PORT

(71) Applicant: Shawn Michael Sokol, Sparta, NJ (US)

(72) Inventor: Shawn Michael Sokol, Sparta, NJ (US)

(21) Appl. No.: 15/283,773

(22) Filed: Oct. 3, 2016

(51) Int. Cl. F21K 9/238; F21K 9/232; F21V 3/02; F21K 9/235; F21V 23/06; F21V 23/04; F21V 19/00; H01R 33/92; H01R 24/60

(52) U.S. Cl. CPC F21K 9/238; F21K 9/232; F21V 3/02; F21K 9/235; H01R 2107/00; F21V 23/04; F21V 19/006; H01R 33/92; H01R 24/60; F21V 23/06

(57) ABSTRACT

A light bulb with at least one USB port is provided. The light bulb includes a translucent housing having an open bottom. A light emitter is disposed within the translucent housing so as to emit light through the housing. A base is secured to the open bottom of the translucent housing. The base includes an electrical connector connected to the light emitter and operable to connect with a light socket. For example, the electrical connector may be a male threaded electrical connector. At least one USB port, such as a pair of USB ports, is disposed in the base and connected to the electrical connector.

### BACKGROUND OF THE INVENTION

The present invention relates to light bulbs and, more particularly, to light bulbs with at least one universal serial bus port.

USB, short for Universal Serial Bus, is an industry standard developed in the mid-1990s that defines the cables, connectors and communications protocols used in a bus for connection, communication, and power supply between computers and electronic devices. USB was designed to standardize the connection of computer peripherals (including keyboards, pointing devices, digital cameras, printers, portable media players, disk drivers and network adapters) to personal computers, both to communicate and to supply electric power. It has become commonplace on other devices, such as smartphones, PDs and video game consoles. USB has effectively replaced a variety of earlier interfaces, such as parallel ports, as well as separate power chargers for portable devices.

As can be seen, there is a need additional access to USB ports to connect with portable devices.

### SUMMARY OF THE INVENTION

In one aspect of the present invention, a light bulb comprises: a translucent housing comprising an open bottom; at least one light emitter within the translucent housing so as to emit light through the housing; and a base secured to the open bottom of the translucent housing, wherein the base comprises: an electrical connector connected to the at least one light emitter and operable to connect with a light socket; and at least one USB port connected to the electrical connector.

In another aspect of the present invention, a light bulb comprises: a translucent housing comprising an open bottom; at least one light emitter within the translucent housing so as to emit light through the housing; a base secured to the open bottom of the translucent housing, wherein the base comprises: an electrical connector connected to the at least one light emitter and operable to connect with a light socket; and at least one USB port connected to the electrical connector; a first circuit comprising a voltage regulator connected to the electrical connector, the at least one light emitter connected to the voltage regulator and at least one switch operable to open and close the first circuit; and a second circuit comprising an AC to DC transformer, a voltage regulator connected to the AC to DC transformer and the at least one USB port connected to the voltage regulator.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use;

FIG. 2 is a perspective view of an embodiment of the present invention;

FIG. 3 is a perspective view of an embodiment of the present invention; and

FIG. 4 is a schematic view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes one or more universal serial bus port (USB) charging output ports built into a base of a light bulb. The present invention eliminates the need for electronic transformers used to charge and run various electronic devices used in everyday life, such as cell phones, tablets and the like. The present invention replaces stand alone 5V AC to DC USB transformers and creates a more convenient and less intrusive charging location, such as in reading lamps.

In certain embodiments, the present invention may include a first circuit for the light emitter and a second circuit for the USB ports. This allows the USB ports to be always electrically connected and the light emitter turned on and off. The AC input enters through the bulb base traveling to a switch and USB stepdown transformer simultaneously. The power to the transformer is may always be on and ready to use. A switch or button is used to turn the light on and off.

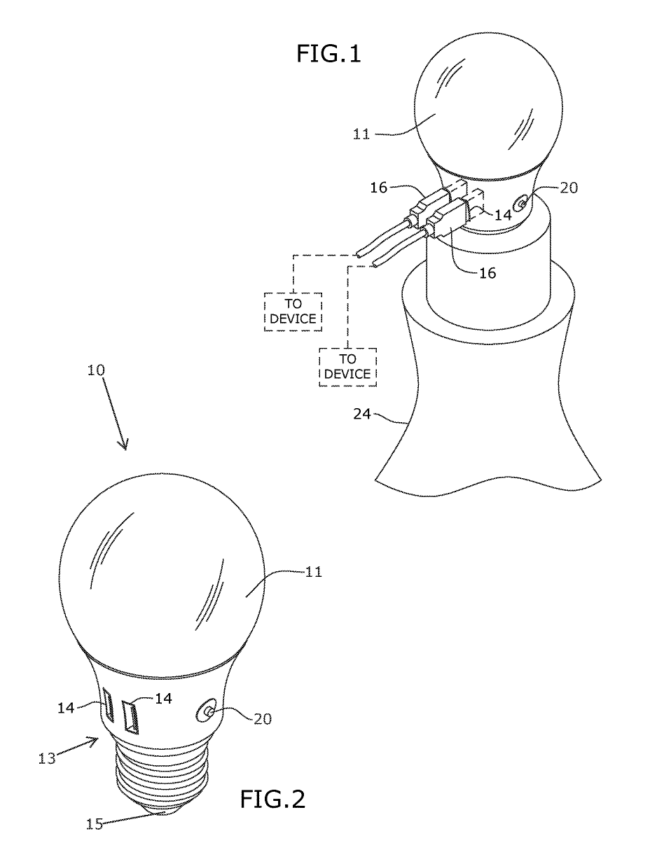

Referring to FIGS. 1 through 4, the present invention includes a light bulb 10. The light bulb 10 includes a translucent housing 11 having an open bottom. A light emitter 34 is disposed within the translucent housing 11 so as to emit light through the housing 11. A base 13 is secured to the open bottom of the translucent housing 11. The base 13 includes an electrical connector 15 connected to the light emitter 34 and operable to connect with a light socket. For example, the electrical connector 15 may be a male threaded electrical connector 15. At least one USB port 14, such as a pair of USB ports 14, is disposed in the base 13 and connected to the electrical connector 15.

The present invention may include a first circuit 25 and a second circuit 27. The first circuit 25 includes the at least one light emitter 34 and the second circuit 27 includes the at least one USB port 14. The first circuit 25 may further include a voltage regulator 30 connected to the electrical connector 15, the at least one light emitter 34 connected to the voltage regulator 30, an r sense 38 and at least one switch 32 operable to open and close the first circuit 25. The base 13 may further include a button 20 or sensor operably connected to the at least one switch 32 and protruding from an outer surface of the base 13. In such embodiments, a power source 26 may be connected to the electrical connector 15 and the light emitter 34 may be turned on and off via the button 20.

While the light emitter 34 may be turned on and off, the USP ports 14 may always provide power as long as the power source 26 is connected to the electrical connector 15. The second circuit 27 includes an AC to DC transformer 28, a voltage regulator 30 connected to the AC to DC transformer 28 and the USB port 14 connected to the voltage regulator 30. The AC to DC transformer 28 is operable to convert 110V of AC to 5V of DC, which is standard for USB ports 14.

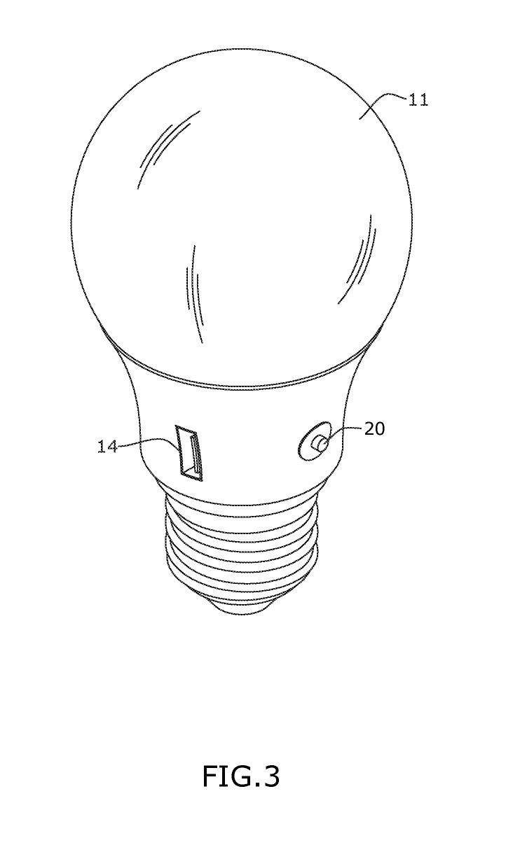

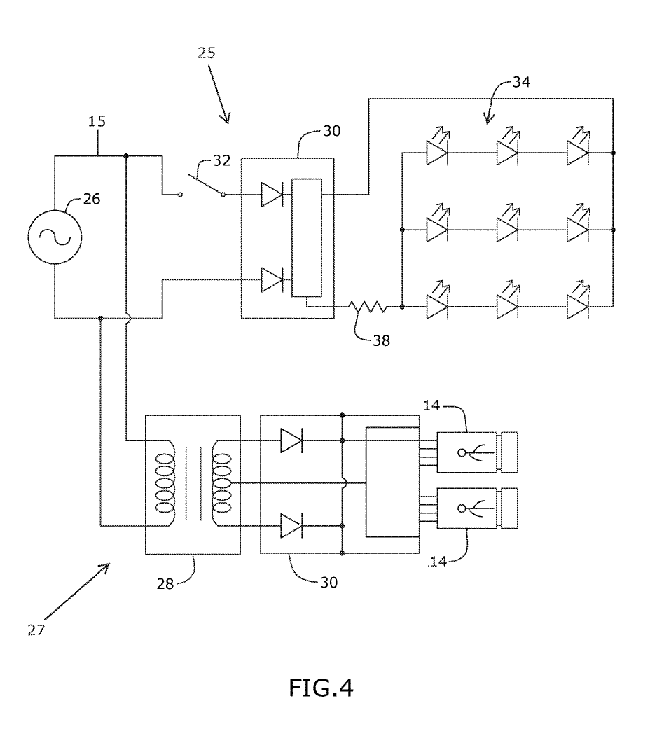

The at least one USB port 14 may include a plurality of USB ports 14. However, as illustrated in FIG. 3, the present invention may only include one USB port 14. The light emitter 25 may include a plurality of Light Emitting Diodes (LEDs) as illustrated in FIG. 4. The light emitter 25 may also include a fluorescent light, an incandescent light, and the like.

Using the present invention, replace any existing light bulb with the present invention. For example, the threaded electrical connector 15 may be secured to a lamp 24. A user may now use the light bulb 10 of the present invention to charge or power any device that runs on 5 VDC power, such as EG Cell phones, tablets, cameras and the like, without a separate transformer or charger that is typically plugged into a wall outlet. A USB cord 16 is electrically connected to the device to be charged and the USB cord 16 is inserted into the USB port 14 of the present invention.

It should be understood, of course, that the foregoing relates to exemplary embodiments of the invention and that modifications may be made without departing from the spirit and scope of the invention as set forth in the following claims.

What is claimed is:

1. A light bulb comprising:
a translucent housing comprising an open bottom;
at least one light emitter within the translucent housing so as to emit light through the housing; and
a base secured to the open bottom of the translucent housing, wherein the base comprises:
an electrical connector connected to the at least one light emitter and operable to connect with a light socket; and
at least one USB port connected to the electrical connector.

2. The light bulb of claim 1, further comprising a first circuit comprising the at least one light emitter and a second circuit comprising the at least one USB port.

3. The light bulb of claim 2, wherein the first circuit comprises a voltage regulator connected to the electrical connector, the at least one light emitter connected to the voltage regulator and at least one switch operable to open and close the first circuit.

4. The light bulb of claim 3, wherein the base further comprises a button operably connected to the at least one switch and protruding from an outer surface of the base.

5. The light bulb of claim 2, wherein the second circuit comprises an AC to DC transformer, a voltage regulator connected to the AC to DC transformer and the at least one USB port connected to the voltage regulator.

6. The light bulb of claim 1, wherein the at least one USB port comprises a plurality of USB ports.

7. A light bulb comprising:
a translucent housing comprising an open bottom;
at least one light emitter within the translucent housing so as to emit light through the housing;
a base secured to the open bottom of the translucent housing, wherein the base comprises:
an electrical connector connected to the at least one light emitter and operable to connect with a light socket; and
at least one USB port connected to the electrical connector;
a first circuit comprising a voltage regulator connected to the electrical connector, the at least one light emitter connected to the voltage regulator and at least one switch operable to open and close the first circuit; and
a second circuit comprising an AC to DC transformer, a voltage regulator connected to the AC to DC transformer and the at least one USB port connected to the voltage regulator.

8. The light bulb of claim 7, wherein the at least one USB port comprises a plurality of USB ports.

9. The light bulb of claim 7, wherein the base further comprises a button operably connected to the at least one switch and protruding from an outer surface of the base.

10. The light bulb of claim 7, wherein the at least one light emitter is at least one of a fluorescent light, an incandescent light, and a Light Emitting Diode.
